(19) United States
(12) Patent Application Publication
(10) Pub. No.: US 2009/0184136 A1
(43) Pub. Date: Jul. 23, 2009

(54) Squeeze action foam pump

(76) Inventor: Nick E. Ciavarella, Seven Hills, OH (US)

Correspondence Address: Mark L. Weber;Fourth Floor, First National Tower, Akron, OH, 44308-1456, US

(21) Appl. No.: 12/009,536

(22) Filed: Jan. 18, 2008

(51) Int. Cl. B67D 5/58; B67D 5/52

(52) U.S. Cl. 222/190; 222/135

(57) ABSTRACT

A foam dispenser includes a foam pump communicating with the contents of a container holding a foamable liquid. The foam pump includes a pump body, a passage extending through the pump body from an inlet to an outlet, an inlet valve including an inlet flow regulator, and an outlet valve including an outlet flow regulator. The inlet receives foamable liquid from the container. The inlet valve and outlet valve are positioned in the passage to define (a) an inlet stage, (b) an outlet stage, and (c) a transition stage. A liquid port extends through the pump body and communicates with the transition stage, and an air port extends through the pump body and communicates with the outlet stage. A liquid bellows surrounds the liquid port and an air bellows surrounds the air port. The liquid bellows contains the foamable liquid and is movable between an expanded volume and a contracted volume, and expels at least a portion of the foamable liquid to the passage through the liquid port when moved from its expanded volume to its contracted volume. The air bellows contains air and is movable between an expanded volume and a contracted volume, and expels at least a portion of the air to the passage through the air port when moved from its expanded volume to its contracted volume.

### TECHNICAL FIELD

The invention herein resides in the art of foam pump, wherein a foamable liquid and air are combined to dispense a foam product. More particularly, the invention relates to a pump wherein air and foamable liquid are pumped through separate components into a common chamber and are extruded through a screen member to create a uniform foam.

### BACKGROUND OF THE INVENTION

For many years, it has been known to dispense liquids, such as soaps, sanitizers, cleansers, disinfectants, and the like from a dispenser housing maintaining a refill unit that holds the liquid and provides the pump mechanisms for dispensing the liquid. The pump mechanism employed with such dispensers has typically been a liquid pump, simply emitting a predetermined quantity of the liquid upon movement of an actuator. Recently, for purposes of effectiveness and economy, it has become desirable to dispense the liquids in the form of foam, generated by the interjection of air into the liquid. Accordingly, the standard liquid pump has given way to a foam generating pump, which necessarily requires means for combining the air and liquid in such a manner as to generate the desired foam.

Typically, foam pumps include an air pump portion and a fluid pump portion—the two requiring communication to ultimately create the foam. Such pumps have been provided through various types of pump structures, as know by those familiar with the foam pump arts. This invention provides a particularly compact foam pump of a structure heretofore unknown in the art.

### SUMMARY OF THE INVENTION

A foam dispenser in accordance with this invention includes a foam pump communicating with the content of a container holding a foamable liquid for dispensing. The foam pump includes a pump body, a passage extending through the pump body from an inlet to an outlet thereof, an inlet valve including an inlet flow regulator, and an outlet valve including an outlet flow regulator. The inlet receives foamable liquid from the container. The inlet valve and outlet valve are positioned in the passage such that the inlet flow regulator and the outlet flow regulator define (a) an inlet stage from the inlet to the inlet flow regulator, (b) an outlet stage from the outlet flow regulator to the outlet, and (c) a transition stage from the inlet flow regulator to the outlet flow regulator. A liquid port extends through the pump body and communicates with the transition stage, and an air port extends through the pump body and communicates with the outlet stage. A liquid bellows surrounds the liquid port and is sealed to the pump body, and an air bellows surrounds the air port and is sealed to the pump body. The liquid bellows contains the foamable liquid and is movable between an expanded volume and a contracted volume, and expels at least a portion of the foamable liquid to the passage through the liquid port when moved from its expanded volume to its contracted volume. Similarly, the air bellows contains air and is movable between an expanded volume and a contracted volume, and expels at least a portion of the air to the passage through the air port when moved from its expanded volume to its contracted volume.

### DESCRIPTION OF THE DRAWINGS

FIG. 1 is a cross sectional view of the foam pump of this invention;

FIG. 2 is a general perspective view of a valve embodiment that is used for both an inlet valve and an outlet valve; and

FIG. 3 is a side elevation of the valve of FIG. 2.

### DETAILED DESCRIPTION OF THE INVENTION

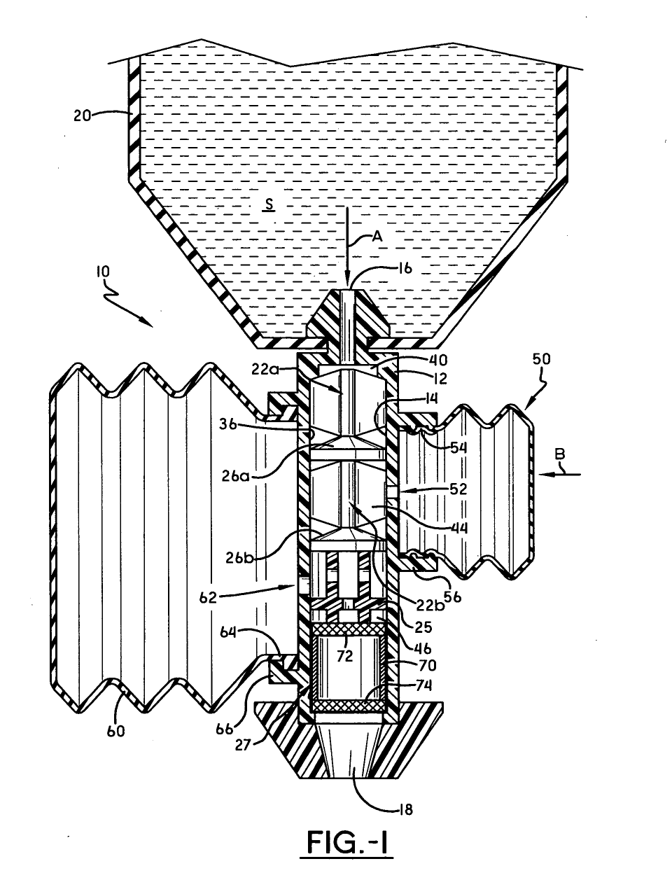

In FIG. 1, the pump of this invention is shown in cross section, and designated generally by the numeral 10. The pump 10 consists of a body 12 providing a passage 14 from an inlet 16 to an outlet 18 thereof. The inlet 16 fluidly communicates with a source of liquid, for example, with a volume of soap S within a container 20. Actuation of the pump 10 serves to dispense the liquid at outlet 18. In this case, the liquid is the soap S provided by the container 20, but other liquids and other liquid sources could be employed.

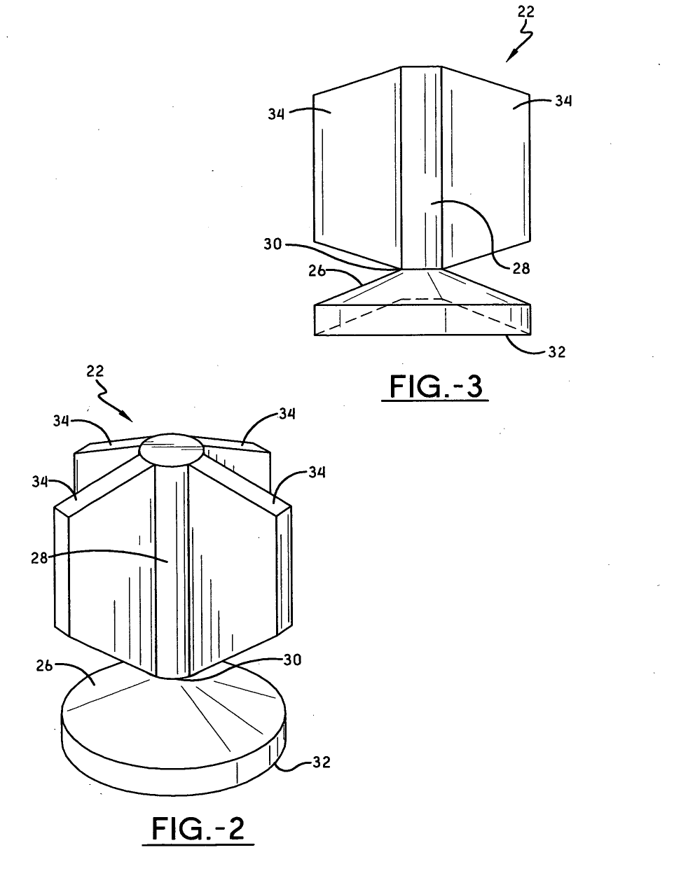

An inlet valve 22a, an outlet valve 22b, a spacer 26, and a mixing cartridge 28 are placed in passage 14 in series, as shown, from inlet 16 to outlet 18. The inlet valve 22a and outlet valve 22b are preferably identical to reduce the number of parts needed to construct the pump 10. In a particular embodiment, both inlet valve 22a and outlet valve 22b are shaped and function as shown in FIGS. 2 and 3 and described herein. Because this valve can be either an inlet valve or and outlet valve, no designation of “a” of “b” is used. Those designations are used, however, in FIG. 1 to help describe the functioning of the invention.

In FIGS. 2 and 3, valve 22 includes a conical wall 26 on the end of a stem 28, with the apex 30 of the conical wall 26 being secured to the stem 28 and widening as it extends away from stem 28 to base 32. Fins 34 extend radially from stem 28. Any number of fins 34 may be employed, but four fins 34 offset at 90 degrees, as shown, are sufficient. As seen in FIG. 1, the fins and the base of inlet valve 22a extend to contact the sidewall 36 defining passage 14. Similarly, the fins and the base of outlet valve 22b extend to contact the sidewall 36. The fins help to stabilize each valve 22a, 22b in passage 14, and the conical walls function to regulate flow of the soap S through the passage 14. The conical walls are flexible so they can collapse in the direction of arrow A to permit fluid to be forced therethrough, but will resist flow in the opposite direction due to contact between the conical walls and the sidewall 36.

The conical wall 26a of inlet valve 22a and the conical wall 26b of valve 22b serve to define the following stages of passage 14. An inlet stage 40 is defined between inlet 16 and the conical wall 26a. A transition stage 44 is defined between conical wall 26a and conical wall 26b. And an outlet stage 46 is defined between conical wall 26b and outlet 18. A liquid bellows 50 fluidly communicates with transition stage 44 of passage 14 through a liquid port 52, and is sealed at its base 54 to post 56 extending outwardly around the liquid port 52. The liquid bellows 50 is resilient such that it can be forced in the direction of arrow B to a contracted volume, and, from this contracted state, will spring back in the direction opposite arrow B to an expanded volume (FIG. 1). When forced to the contracted volume, any soap S within the liquid bellows 50 will be forced into transition stage 44, and the conical wall 26a of inlet valve 22a will prevent movement of any soap S in transition stage 44 in the direction of inlet 16. Thus conical wall 26b of outlet valve 22b is forced to flex to permit soap S to advance from transition stage 44 to outlet stage 46. When the liquid bellows 50 is thereafter permitted to spring back to its expanded volume, a vacuum is created in transition stage 44, and the conical wall 26b of outlet valve 22b will prevent the vacuum from drawing soap and/or air into transition stage 44 from the outlet stage 46. Instead, conical wall 26a of inlet valve 22a will flex to permit soap S to advance from inlet stage 40 into transition stage 44. Thus, when the passage 14 is full of soap S, actuation of liquid bellows 50 causes a dose of soap S to be advanced toward and out of outlet 18, and releasing of the liquid bellows 50 causes a new dose of soap S to be drawn into passage 14.

An air bellows 60 fluidly communicates with outlet stage 46 of passage 14 through air port 62, and is sealed at its base 64 to post 66 extending outwardly around air port 62. As with liquid bellows 50, the air bellows 60 is resilient and can be forced to a contracted volume and can spring back to an expanded volume. When forced to the contracted volume, any air within the air bellows 60 will be forced into outlet stage 46, and the conical wall 26b of outlet valve 22b will prevent soap S and air in outlet stage 46 from advancing in the direction of inlet 16. Instead, the air must advance toward outlet 18, through the space occupied by spacer 26 and through the mixing cartridge 28. When the air bellows 60 is thereafter permitted to spring back to its expanded volume, air is drawn into air bellows 60 through outlet 18.

The pump 10 is intended to be used by actuating, i.e., compressing, both liquid bellows 50 and air bellows 60 at the same time. From the foregoing description of each of those bellows, it should be appreciated that by simultaneously compressing both liquid bellows 50 and air bellows 60, air and soap S will be caused to mix at outlet stage 46. First, the soap S and air will form a coarse mix at a premix stage defined by spacer 26, but this coarse mix will then be forced through a mesh screen, or, as shown here, a mixing cartridge 28 to create a uniform foam for dispensing at outlet 18. The mixing cartridge 28 is sufficiently shown in FIG. 1 as tube 70 bounded on an inlet side by screen 72 and on an outlet side by screen 74. Thus, when both liquid bellows 50 and air bellows 60 are actuated at the same time, a dose of foamed soap is created at mixing cartridge 28 and dispensed at outlet 18.

1. A foam dispenser comprising:
a container holding a foamable liquid for dispensing;
a pump body;
a passage extending through said pump body from an inlet to an outlet thereof, said inlet receiving foamable liquid from said container;
an inlet valve including an inlet flow regulator and an outlet valve including an outlet flow regulator, the inlet valve and outlet valve being positioned in said passage such that said inlet flow regulator and said outlet flow regulator define an inlet stage from said inlet to said inlet flow regulator, an outlet stage from said outlet flow regulator to said outlet, and a transition stage from said inlet flow regulator to said outlet flow regulator;
a liquid port extending through said pump body and communicating with said transition stage;
a liquid bellows surrounding said liquid port and sealed to said pump body, said liquid bellows containing foamable liquid and being movable between an expanded volume and a contracted volume and expelling at least a portion said liquid to said passage through said liquid port when moved from said expanded volume to said contracted volume;
an air port extending through said pump body and communicating with said outlet stage;
an air bellows surrounding said air port and sealed to said pump body, said air bellows containing air and being movable between an expanded volume and a contracted volume and expelling at least a portion of said air to said passage through said air port when moved from said expanded volume to said contracted volume.
